(19) United States
(12) Patent Application Publication
(10) Pub. No.: US 2018/0288189 A1
(43) Pub. Date: Oct. 4, 2018

(54) VERSION DETERMINATION FROM AN HTTP REQUEST

(71) Applicant: HEWLETT PACKARD ENTERPRISE DEVELOPMENT LP, Houston, TX (US)

(72) Inventors: Adnan Isajbegovic, Sarajevo (BA); Hugh Hamill, Galway (IE); Andrej Marolt, Ljubljana (SI); Mark Davis, Galway (IE); Nemanja Golubovic, Galway (IE)

(21) Appl. No.: 15/471,984

(22) Filed: Mar. 28, 2017

(51) Int. Cl. H04L 29/08; H04L 12/24; H04L 29/06

(52) U.S. Cl. CPC H04L 67/327; H04L 69/22; H04L 41/0859; H04L 67/2842

(57) ABSTRACT

In one example in accordance with the present disclosure, a method may include receiving an HTTP request. The method may include determining a content type requested by the HTTP request and a requested date associated with the content type and determining an origin date corresponding to a version of the content type nearest to the requested date that is before the requested date. The method may include generating a new HTTP request including the version of the content type and transmitting the new HTTP request.

### BACKGROUND

Client devices may make application program interface (API) calls to access different resources. However, developers may update these resources periodically, leading to a situation where different versions (and thus different version numbers) exist.

### BRIEF DESCRIPTION OF THE DRAWINGS

The following detailed description references the drawings, wherein:

FIG. 1 is a block diagram of an example environment for version determination from an Hypertext Transfer Protocol (HTTP) Request;

FIG. 2 is a flowchart of an example method for version determination from an HTTP Request;

FIG. 3 is a flowchart of an example method for generating a new HTTP request;

FIG. 4A is a flowchart of an example method for version determination;

FIG. 4B is a flowchart of another example method for version determination;

FIG. 5 is a block diagram of an example system for version determination from an HTTP Request; and

FIG. 6 is a block diagram of another example system for version determination from an HTTP Request.

### DETAILED DESCRIPTION

A developer may include the version number of a desired resource in an Hypertext Transfer Protocol (HTTP) Request, such as a representational state transfer (REST) call. However, as resources are updated, multiple versions of these resources may exist. This may lead to a situation where a user, such as a programmer, has to adjust the version numbers in the HTTP requests to ensure compatibility. In other words, a user that makes calls using the API may have to keep track of the latest version numbers in order to include those numbers in the an HTTP request calls.

Systems and methods for version determination from an HTTP request discussed herein may use content release date based versioning that provides a way to make internal routing to different versions of the same HTTP request based on optional headers. If those headers are not present or do not point to existing routes, default routes may be used to access a default version of a resource, such as a content type. The default version of the resource may be the oldest supported resource. For example, in an aspect where preserving backwards compatibility is desired, it may be assumed that HTTP requests without HTTP headers for versioning may not have adopted/updated to the new resource representations. Accordingly, the oldest version may be used so as not to break the old clients.

Content type may include, for example, content type supported by the API, other types of content, etc. As used herein content type refers to the type of data that is specified by the HTTP request. Content may refer to media, methods and/or other functionalities supported by the API and this included in the HTTP request. In other words, a user calling a content type does not need to worry about tracking different version numbers of different content types and changing the HTTP request to match. Instead, the client has the freedom to choose a methodology that fits their development needs.

Systems and methods discussed herein may make use of an Inner Cache System that holds information about registered HTTP requests, as well as versions and release dates of content types included in HTTP requests. An incoming HTTP request may be intercepted and the URL and/or header information may be extracted. Using a date and/or version number provided in the header information, the system can determine a corresponding version of the content type to provide to the client. If no date and/or version number exists in the header information, a default version of the content type may be used instead.

A method for version determination from an HTTP request may comprise receiving a HTTP request. The method may include determining a content type requested by the HTTP request and a requested date associated with the content type and determining an origin date corresponding to a version of the content type nearest to the requested date that is before the requested date. The method may include generating a new HTTP request including the version of the content type and transmitting the new HTTP request.

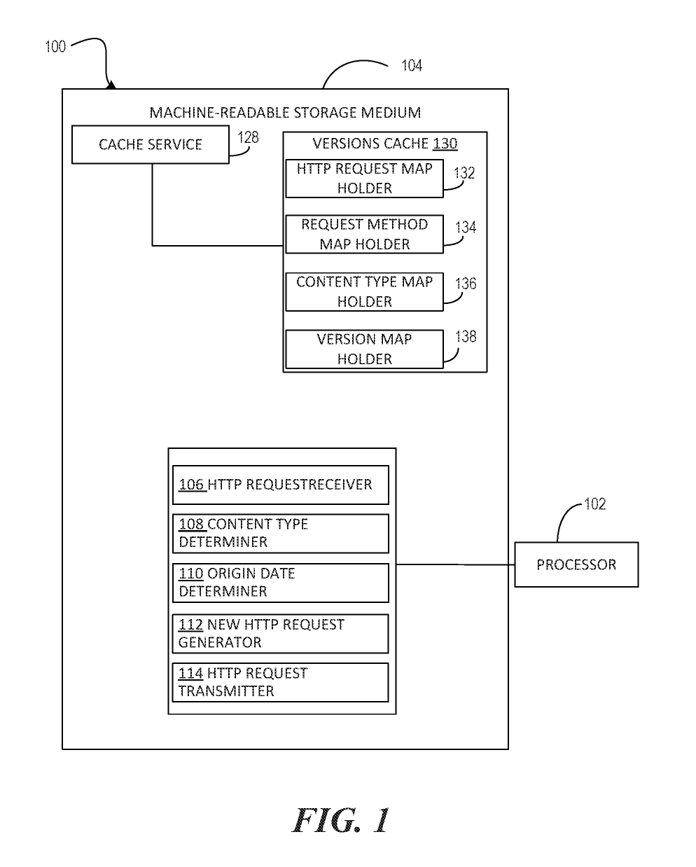

FIG. 1 is a block diagram of an example system 100 for version determination from an HTTP request. System 100 may include a processor 102 and a machine-readable storage medium 104 that may be coupled to each other through a communication link (e.g., a bus). Processor 102 may include a single or multiple Central Processing Units (CPU) or another suitable hardware processor(s). In some examples, machine-readable storage medium 104 stores machine readable instructions executed by processor 102 for system 100. Machine-readable storage medium 104 may include any suitable combination of volatile and/or non-volatile memory, such as combinations of Random Access Memory (RAM), Read-Only Memory (ROM), flash memory, and/or other suitable memory.

Machine-readable storage medium 104 stores instructions to be executed by processor 102 including instructions for HTTP request receiver 106, content type determiner 108, origin date determiner 110, new HTTP request generator 112, HTTP request transmitter 114 and/or other components. According to various implementations, system 100 may be implemented in hardware and/or a combination of hardware and programming that configures hardware. Furthermore, in FIG. 1 and other Figures described herein, different numbers of components or entities than depicted may be used.

Processor 102 may execute HTTP request receiver 106 to receive an HTTP request. For example, the HTTP request receiver 106 may intercept the HTTP request in order to extract specified data from the HTTP request. Processor 102 may execute content type determiner 108 to determine a content type requested by the HTTP request and/or a requested date associated with the content type. The HTTP request may include a Uniform Resource Locator (URL) and HTTP headers. The headers may include content type header information indicating a requested content type. In some cases, the content type header information may also include a version number associated with the requested content type. The HTTP request may further include a date header containing date information such as requested date associated with the content type. Generally the client requests a certain content type by using a “content type header information” header (sometimes reffered to as an “Accept header”). A server may respond with the requested content and provides the content type by using a server content header (sometimes referred to as a “Content-type header”)

Processor 102 may execute origin date determiner 110 to determine an origin date corresponding to a version of the content type nearest to the requested date that is before the requested date. Origin date determiner 110 may make use of a cache service 128 to determine the proper version number for the desired content type based on the information provided in the initial HTTP request (such as the header information). Versions Cache 130 may contain holders, such as HTTP request map holder 132, request method map holder 134, produce type map holder 136 and version map holder 138. HTTP request map holder 132 may contain a map of each method of the API available to be used in HTTP requests. Request method map holder 134 may contain, for each of the methods in the API, a map of each request methods for specific base HTTP request in the API. Request methods are a defined set of desired actions that can performed for a given resource (content type, etc.).

Content type map holder 136 may contain, for each request method in the request method map holder 134, each of the content type related to specific request Method and base HTTP request. Version map holder 138 may contain a listing of versions and corresponding origin dates, for each of the content types supported by the API. For example, each unique combination of HTTP request, request method and/or content type may be associated with a version number. Version map holder 138 may also contain a default version for each content type. In some aspects, the default version may be the newest version, which may be the version with the latest origin date. In some aspects, the default version may be the oldest version, which may be the version with the oldest origin date. Of course these are examples, as other versions may be used as the default version.

Origin date determiner 110 may use the header information to determine a version of the content type from the versions cache 130. For example, origin date determiner 110 may determine whether a version is included in the header information. If origin date determiner 110 determines that a version is present in the header information, then origin date determiner 110 may determine an origin date corresponding to the version from the holders in the version cache 130.

If origin date determiner 110 determines that a version is not present in the header information, origin date determiner 110 may determine a default version for the content type from the version map older 138. The origin date of the default version may be used as the origin date of the content type. In some aspects, an incorrect version number may be included in the header information, for instance a version that does not exist. If the version is not present in the versions cache 130, the default version may be used or an error may be sent to the user. Either an error can be sent as the result or the default version can be used. In some aspects, both a version number and a requested date may be included in the header information. In these aspects, the origin date determiner 110 may determine which, if any, of the two has a higher priority. The priority may be set by the user, the developer of the API, etc.

Processor 102 may execute new HTTP request generator 112 to generate a new HTTP request including the version of the content type. The version of the content type may be included in the header information and/or the URL of the new HTTP request. Processor 102 may execute HTTP request transmitter 114 to transmit the new HTTP request. The new HTTP request may be used to call the version of the desired content type and may return the result to the caller. Thus, based on the new HTTP request, a server may return the desired content type to the client device which submitted the original HTTP request. If the version of the content type provided in the received HTTP request is a different version then provided in the new HTTP request (or if no version information was provided in the received HTTP request), the version provided in the new HTTP request may be masked as the content type with the version given in the received HTTP request. In other words, when the new HTTP request is viewed by the client, the version number may match the version number listed in the original HTTP request. In this manner, any systems of the client which may rely on the version number being identical to the version number used in the original HTTP request.

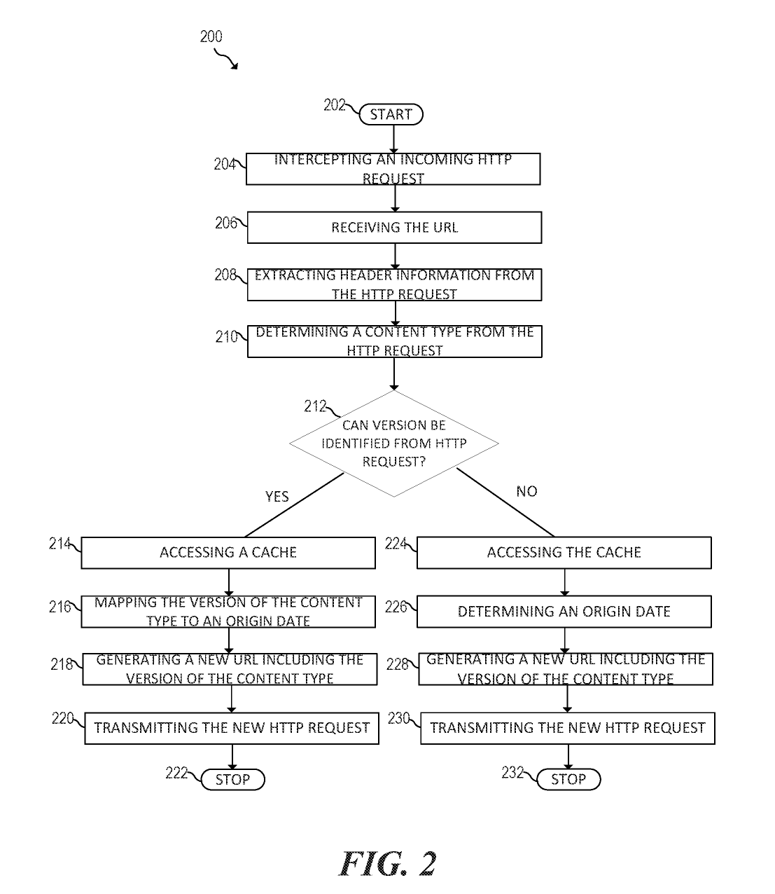

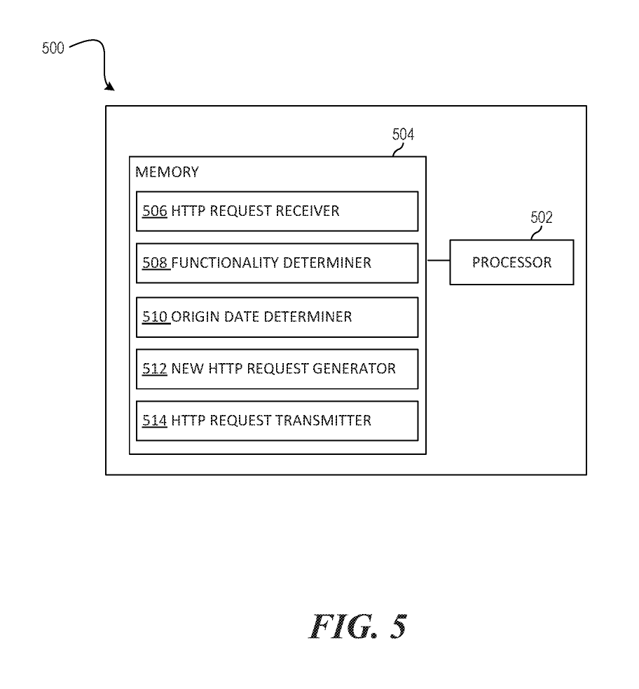

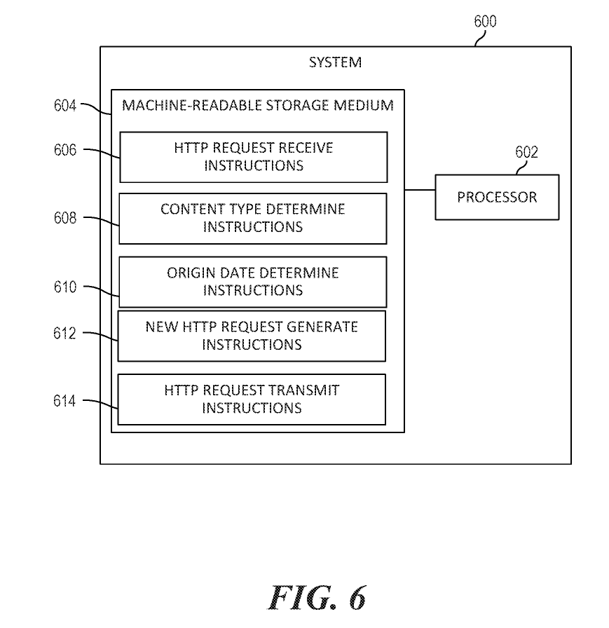

Referring now to FIGS. 2-4B, flow diagrams are illustrated in accordance with various examples of the present disclosure. The flow diagrams represent processes that may be utilized in conjunction with various systems and devices as discussed with reference to the preceding figures, such as, for example, system 100 described in reference to FIG. 1, system 500 described in reference to FIG. 5 and/or system 600 described in reference to FIG. 6. While illustrated in a particular order, the flow diagrams are not intended to be so limited. Rather, it is expressly contemplated that various processes may occur in different orders and/or simultaneously with other processes than those illustrated. As such, the sequence of operations described in connection with FIGS. 2-4B are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples.

FIG. 2 is a flowchart of an example method 200 for version determination from HTTP request. Method 200 may start at block 202 and continue to block 204, where the method 200 may include intercepting an incoming HTTP request. At block 206, the method may include receiving the HTTP request and at block 208, the method may include extracting header information and/or a URL from the HTTP request. The header information may include content type header information containing a content type and/or a version number associated with that content type. The header information may include a date header containing date information such as the requested date associated with the content type. At block 210, the method may include determining a content type from the header information, such as the content type header information. The content type may include a content type and/or method provided by an API associated with the HTTP request and/or REST call.

At block 212, the method may include determining whether a version of the desired content type can be identified from the header information. The version number may be identified, for example, from the header information. If it is determined that the version of the content type can be identified from the header information (YES branch of block 212), at block 214, the method may involve accessing a cache. The cache may include a listing of a plurality of content types associated with the API. Each content type may have multiple versions listed in the cache and each version may have a corresponding origin date.

At block 216, the method may include mapping the version of the content type to an origin date. Mapping the version of the content type to an origin date may include accessing the listing of the version of the content type from the cache, determining the origin date associated with that version and associating the origin date to the content type. At block 218, the method may include generating a new HTTP request including the version of the content type and at block 220 the method may include transmitting the new HTTP request. The new HTTP request code may be used to call the version of the desired content type and may return the result to caller. The method may continue to block 222, where the method may end.

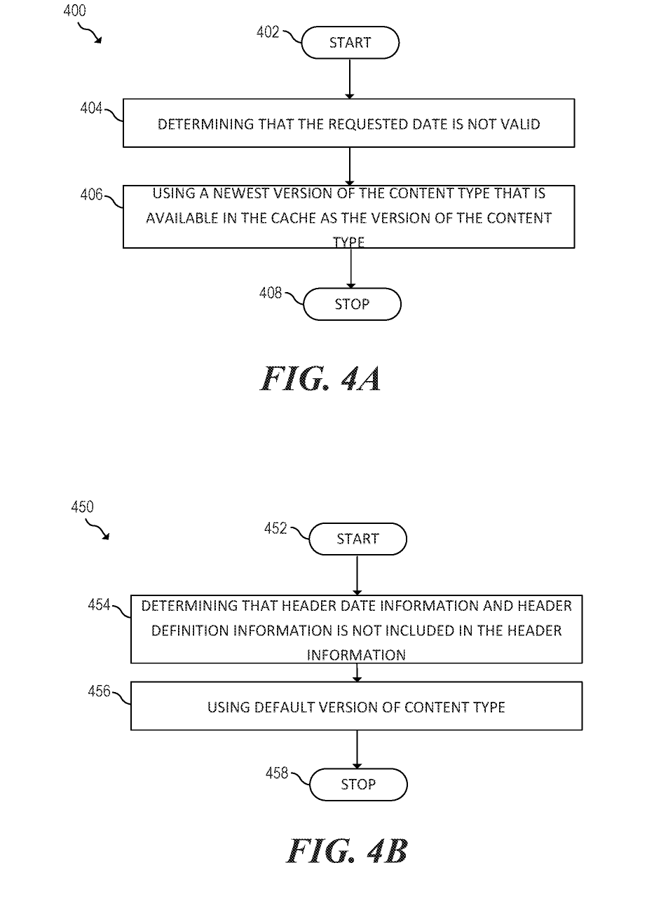

As described above, the method may use the origin date to determine the version number rather than use the version number directly. This may be beneficial, for example, in a situation where the original HTTP request includes an incorrect version number. In such a scenario, the method may include determining that the version number is incorrect and using the default version as the version. This is discussed in further detail below in regards to FIG. 4A.

If it is determined that the version of the content type cannot be identified from the header information (NO branch of block 212), at block 224, the method may involve accessing a cache. The cache may include a listing of a plurality of content types associated with the API. Each content type may have multiple versions listed in the cache and each version may have a corresponding origin date.

At block 226, the method may include determining an origin date for the content type. The method may include determining an origin date for the content type in a variety of ways. The method may determine whether requested date is provided in the HTTP request and/or header information. If a requested date is provided in the header information, than that origin date may be associated with the content type. If a requested date is not provided in the HTTP request, header information, the method may use a default value of an origin date associated with the content type. The default value may, for example, be an origin date associated with a default version of the content type. The method may include accessing the listing of the content type from the cache, determining the origin date associated with the default version and associating the origin date of the default version to the content type.

At block 228, the method may include generating a new HTTP request and/or URL including the version of the content type and at block 230 the method may include transmitting the new HTTP request. The new HTTP request code may be used to call the version of the desired content type and may return the result to caller. The method may continue to block 232, where the method may end.

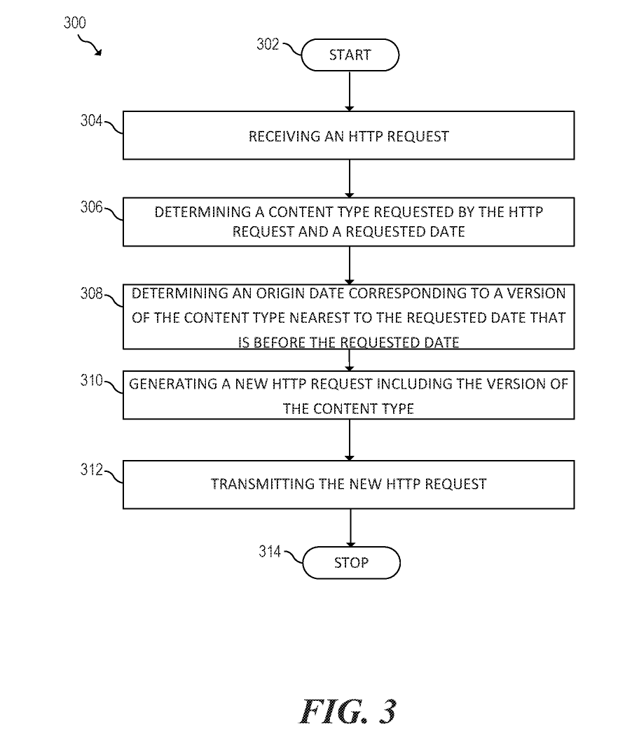

FIG. 3 is a flowchart of an example method 300 for version determination from HTTP request. Method 300 may start at block 302 and continue to block 304, where the method 300 may include receiving a locator HTTP request. At block 306, the method may include determining a content type requested by the HTTP request and a requested date associated with the content type. Determining the requested date associated with the content type may comprise determining the requested date from the header information. At block 308, the method may include determining an origin date corresponding to a version of the content type nearest to the requested date that is before the requested date. At block 310, the method may include generating a new HTTP request including the version of the content type and at block 312, the method may include transmitting the new HTTP request. The method may continue to block 314, where the method may end.

FIG. 4A is a flowchart of an example method 400 for version determination. Method 400 may start at block 402 and continue to block 404, where the method may include determining that the requested date is not valid. At block 406, the method may include using a default version of the content type that is available in the cache as the version of the content type. The method may continue to block 408, where the method may end.

FIG. 4B is a flowchart of an example method 450 for version determination. Method 450 may start at block 452 and continue to block 454, where the method may include determining that header date information and header definition information is not included in the header information. At block 456, the method may include using a default version of the content type. The default version may be specified by the user, may be specified by the developer of the API, etc. The method may continue to block 458, where the method may end.

FIG. 5 is a block diagram of an example system 500 for version determination from HTTP request. System 500 may include a processor 502 and a memory 504 that may be coupled to each other through a communication link (e.g., a bus). Processor 502 may include one or multiple Central Processing Units (CPU) or another suitable hardware processors. In some examples, memory 504 stores machine readable instructions executed by processor 502 for system 500. Memory 504 may include any volatile memory, non-volatile memory, or any suitable combination of volatile and non-volatile memory. Memory 504 may comprise, for example, may be, for example, Random Access Memory (RAM), an Electrically-Erasable Programmable Read-Only Memory (EEPROM), a storage drive, an optical disc, and/or other suitable memory. Memory 504 may also include a random access non-volatile memory that can retain content when the power is off.

Memory 504 stores instructions to be executed by processor 502 including instructions for HTTP request receiver 506, functionality determiner 508, origin date determiner 510, new HTTP request generator 512 and HTTP request transmitter 514. The components of system 500 may be implemented in the form of executable instructions stored on at least memory 504 and executed by at least one processor of system 500. Memory 504 may be non-transitory. Each of the components of system 500 may be implemented in the form of at least one hardware device including electronic circuitry for implementing the functionality of the component.

Processor 502 may execute instructions of HTTP request receiver 506 to receive a HTTP request. Receiving the HTTP request may include intercepting an incoming HTTP request, extracting a URL from the HTTP request and extracting header information from the HTTP request. Processor 502 may execute instructions of functionality determiner 508 to determine a functionality requested by the HTTP request and a requested date associated with the functionality. Determining the requested date associated with the functionality may include determining the requested date from the header information. Functionality determiner 508 may further determine that header date information and header definition information is not included in the header information and use the default version of the functionality. Functionality determiner 508 may access a cache to determine the origin date. The cache may include a plurality of functionalities, including the functionality, associated with an application programming interface, and multiple versions of the functionality may be stored in the cache, each version having a corresponding origin date.

Processor 502 may execute instructions of origin date determiner 510 to determine an origin date corresponding to a version of the functionality nearest to the requested date that is before the requested date. Processor 502 may execute instructions of new HTTP request generator 512 to generate a new HTTP request and/or URL including the version of the functionality. Processor 502 may execute instructions of HTTP request transmitter 514 to transmit the new HTTP request. The new HTTP request code may be used to call the version of the desired functionality and may return the result to the caller (e.g. to the client device which submitted the original HTTP request). If the version of the functionality provided in the received HTTP request is a different version then provided in the new HTTP request (or if no version information was provided in the received HTTP request), the version provided in the new HTTP request may be masked as the functionality with the version given in the received HTTP request.

FIG. 6 is a block diagram of an example system 600 for version determination from HTTP request. In the example illustrated in FIG. 6, system 600 includes a processor 602 and a machine-readable storage medium 604. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 602 may be at least one central processing unit (CPU), microprocessor, and/or other hardware devices suitable for retrieval and execution of instructions stored in machine-readable storage medium 604. In the example illustrated in FIG. 6, processor 602 may fetch, decode, and execute instructions 606, 608, 610, 612 and 614 to perform version determination from HTTP request. Processor 602 may include at least one electronic circuit comprising a number of electronic components for performing the functionality of at least one of the instructions in machine-readable storage medium 604. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 604 may be any electronic, magnetic, optical, or other physical storage device that stores executable instructions. Thus, machine-readable storage medium 604 may be, for example, Random Access Memory (RAM), an Electrically-Erasable Programmable Read-Only Memory (EEPROM), a storage drive, an optical disc, and the like. Machine-readable storage medium 604 may be disposed within system 600, as shown in FIG. 6. In this situation, the executable instructions may be “installed” on the system 600. Machine-readable storage medium 604 may be a portable, external or remote storage medium, for example, that allows system 600 to download the instructions from the portable/external/remote storage medium. In this situation, the executable instructions may be part of an “installation package”. As described herein, machine-readable storage medium 604 may be encoded with executable instructions for context aware data backup.

The machine-readable storage medium may be non-transitory. Referring to FIG. 6, HTTP request receive instructions 606, when executed by a processor (e.g., 602), may cause system 600 to receive a HTTP request. Content type determine instructions 608, when executed by a processor (e.g., 602), may cause system 600 to determine a content type requested by the HTTP request and a requested date associated with the content type. Determining the requested date associated with the content type may include determining the requested date from the header information. Content type determine instructions 608, when executed by a processor (e.g., 602), may cause system 600 to determine that header date information and header definition information is not included in the header information and use the default version of the content type. Content type determine instructions 608, when executed by a processor (e.g., 602), may cause system 600 to access a cache to determine the origin date. The cache may include a plurality of content types associated with an application programming interface. The plurality of content types may include the requested content type. Multiple versions of the content type may be stored in the cache, each version having a corresponding origin date.

Origin date determine instructions 610, when executed by a processor (e.g., 602), may cause system 600 to determine an origin date corresponding to a version of the content type nearest to the requested date that is before the requested date. New HTTP request generate instructions 606, when executed by a processor (e.g., 302), may cause system 800 to generate a new HTTP request and/or URL including the version of the content type. HTTP request transmit instructions 606, when executed by a processor (e.g., 302), may cause system 800 to transmit the new HTTP request. The new HTTP request code may be used to call the version of the desired content type and may return the result to caller. If the version of the content type provided in the received HTTP request is a different version then provided in the new HTTP request (or if no version information was provided in the received HTTP request), the version provided in the new HTTP request may be masked as the content type with the version given in the received HTTP request.

The foregoing disclosure describes a number of examples for version determination from an HTTP request. The disclosed examples may include systems, devices, computer-readable storage media, and methods for version determination from HTTP request. For purposes of explanation, certain examples are described with reference to the components illustrated in FIGS. 1-6. The content type of the illustrated components may overlap, however, and may be present in a fewer or greater number of elements and components. Further, all or part of the content type of illustrated elements may co-exist or be distributed among several geographically dispersed locations. Further, the disclosed examples may be implemented in various environments and are not limited to the illustrated examples.

Further, the sequence of operations described in connection with FIGS. 1-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples.

What is claimed is:

1. A method comprising:
receiving a HTTP request;
determining a content type requested by the HTTP request and a requested date associated with the content type;
determining an origin date corresponding to a version of the content type nearest to the requested date that is before the requested date;
generating a new HTTP request including the version of the content type; and
transmitting the new HTTP request.

2. The method of claim 1, wherein determining the origin date comprises:
determining that the version of the content type cannot be determined from the HTTP request.

3. The method of claim 1, wherein determining the origin date comprises:
determining the version of the content type from the HTTP request; and
mapping the version of the content type to the origin date corresponding to the version of the content type.

4. The method of claim 1 comprising:
accessing a cache to determine the origin date, wherein the cache includes a plurality of content types, including the content type, associated with an application programming interface (API).

5. The method of claim 4, wherein the content type has multiple versions stored in the cache, each version having a corresponding origin date.

6. The method of claim 1 comprising:
determining that the requested date is not valid; and
using a default version of the content type that is available in the cache as the version of the content type.

7. The method of claim 1, wherein receiving the HTTP request comprises:
intercepting an incoming REST call;
extracting the HTTP request from the REST call; and
extracting header information from the HTTP request.

8. The method of claim 7, wherein determining the requested date associated with the content type comprises:
determining the requested date from the header information.

9. The method of claim 7 comprising;
determining that header date information and header definition information is not included in the header information; and
using a default version of the content type.

10. A system comprising:
a HTTP request receiver to receive a locator HTTP request;
a functionality determiner to determine a functionality requested by the HTTP request and a requested date associated with the functionality;
an origin date determiner to determine an origin date corresponding to a version of the content type nearest to the requested date that is before the requested date;
a new HTTP generator to generate a new HTTP request including the version of the content type; and
a HTTP request transmitter to transmit the new HTTP request.

11. The system of claim 10, wherein
the HTTP request receiver is to:
intercept an incoming REST call;
extract the HTTP request from the REST call; and
extract header information from the HTTP request.

12. The system of claim 10, wherein
the functionality determiner is to determine the requested date from the header information.

13. The system of claim 11 wherein the functionality determiner is to:
determine that header date information and header definition information is not included in the header information; and
use a default version of the functionality.

14. The system of claim 11 wherein the content type determiner to access a cache to determine the origin date, wherein the cache includes a plurality of functionalities, including the functionality, associated with an application programming interface, wherein multiple versions of each functionality in the plurality of functionalities are stored in the cache, each version having a corresponding origin date.

15. A non-transitory machine-readable storage medium encoded with instructions, the instructions executable by a processor of a system to cause the system to:
receive an HTTP request;
determine a content type requested by the HTTP request and a requested date associated with the content type;
determine an origin date corresponding to a version of the content type nearest to the requested date that is before the requested date;
generate a new HTTP request including the version of the content type; and
transmit the new HTTP request.

16. The non-transitory machine-readable storage medium of claim 15, wherein the instructions executable by the processor of the system to determine the origin date further cause the system to:
determine that the version of the content type cannot be determined from the HTTP request.

17. The non-transitory machine-readable storage medium of claim 15, wherein the instructions executable by the processor of the system to determine the origin date further cause the system to:
determine the version of the content type from the HTTP request; and
map the version of the content type to the origin date corresponding to the version of the content type.

18. The non-transitory machine-readable storage medium of claim 15, wherein the instructions executable by the processor of the system further cause the system to:
determine that the requested date is not valid; and
use a default version of the content type that is available in the cache as the version of the content type.

19. The non-transitory machine-readable storage medium of claim 15, wherein the instructions executable by the processor of the system further cause the system to:
access a cache to determine the origin date, wherein the cache includes a plurality of content types, including the content type, associated with an application programming interface (API).

20. The non-transitory machine-readable storage medium of claim 19, wherein multiple versions of each content type in the plurality of content type are stored in the cache, each version having a corresponding origin date.
